(19) United States
(12) Patent Application Publication
(10) Pub. No.: US 2016/0004991 A1
(43) Pub. Date: Jan. 7, 2016

(54) SYSTEM AND METHOD FOR DELIVERING SALES TRAINING VIDEOS

(71) Applicant: LURNITURE CORP., Toronto (CA)

(72) Inventor: Samuel David BLOOM, Toronto (CA)

(21) Appl. No.: 14/792,371

(22) Filed: Jul. 6, 2015

Related U.S. Application Data
(60) Provisional application No. 62/021,425, filed on Jul. 7, 2014.

(51) Int. Cl. G06Q 10/06

(52) U.S. Cl. CPC G06Q 10/063114

(57) ABSTRACT

Delivering sales training videos includes matching content attributes of the sales training videos data stored at the customer relationship management (CRM) system. Matched sales training videos are sent to one or more remote devices for playback. User-specified feedback data is received from the one or more remote devices. The user-specified feedback data indicates a particular object stored in the CRM system. Upon detection of an advancement of a stage of the particular object, at least one content attribute of the particular sales training video is updated. Future recommendations of sales training videos consider the updated content attribute.

### FIELD

This disclosure relates to computer systems, more specifically, to video content delivery.

### BACKGROUND

Sales departments often employ a number of representatives for handling inbound and outbound leads and opportunities. The nature and size of the opportunities may vary greatly over a short time. For example, outbound sales campaigns may involve originating calls to set a first meeting to start a new sales cycle with a prospect account, offer new products for sale to existing customers or support existing usage. Sales representatives assigned to these opportunities must be familiar with the appropriate sales process stages, objection handling best practises and knowledge of all products being offered for sale. These same sales representatives may also be involved in handling inbound leads/opportunities, and may be required to answer questions associated with various products, customers seeking service, etc. These sales representatives are ideally trained in a variety of areas, including trained in managing a sales process, interacting with other customer information systems for updating customer records within a customer relationship management (CRM) system, researching product features, or for being familiar with guidelines and policies associated with setting up contracts, pricing and quotes. Additionally, it is not uncommon for employee growth and turnover in sales departments to be relatively high, requiring continual training of new representatives.

Training of the sales representatives is important, since training increases their effectiveness. Failure to train a representative can result in poor sales cycles, loss of revenue, and other adverse impacts. These types of issues are prevalent. Presently known training systems for providing computer-based learning allow each sales representative to receive training in a manner that suits the representative's schedule. Some training systems are designed to be locally executed on the representative's computer while other training systems can be hosted on a server and provided to the rep via network interconnection.

However, present training systems are stand-alone, such that accessing the right content on those systems requires a lot of time and luck, causing administrative burdens to coordinate training between the reps, CRM systems, and the training infrastructure. The administration process of accomplishing training is disjointed from other scheduling. Furthermore, prior art generally rely on generic content that is pushed one way, and can lack usability in that content can reside in back end systems that are not accessible when needed.

### SUMMARY

According to one aspect of the present invention, a method for delivering sales training videos in a computer network includes obtaining content attributes of the sales training videos. The sales training videos are stored in a library of sales training videos accessible to a customer relationship management system operating on the computer network, the content attributes identifying relationships between content of sales training videos and data stored at the customer relationship management system. The method further includes selecting one or more of the sales training videos based on the content attributes of the sales training videos, outputting indications of the one or more sales training videos to a remote device via the computer network, and initiating playback for the remote device of a particular sales training video of the one or more sales training videos. The method further includes, after or during playback of the particular sales training video, outputting a feedback request to the remote device via the computer network. The method further includes receiving user-specified feedback data from the remote device via the computer network, the user-specified feedback data indicating a particular CRM object stored in the customer relationship management system. The method further includes upon detection of an advancement of CRM objecta stage of the particular CRM object, updating at least one content attribute of the particular sales training video.

According to another aspect of the present invention, a sales training video system includes content attributes identifying relationships between content of sales training videos and data stored at a customer relationship management system. The sales training videos are stored in a library of sales training videos accessible to a customer relationship management system operating on a computer network. The system further includes a recommendation engine configured to selecting one or more of the sales training videos based on the content attributes of the sales training videos, output indications of the one or more sales training videos to a remote device via the computer network, and initiate playback for the remote device of a particular sales training video of the one or more sales training videos. The recommendation engine is configured to output a feedback request to the remote device via the computer network after or during playback of the particular sales training video. The recommendation engine is configured to receive user-specified feedback data from the remote device via the computer network. The user-specified feedback data indicates a particular CRM object stored in the customer relationship management system. The recommendation engine is configured to update at least one content attribute of the particular sales training video upon detection of an advancement of a stage of the particular CRM object.

### BRIEF DESCRIPTION OF THE DRAWINGS

The drawings illustrate, by way of example only, embodiments of the present disclosure.

FIG. 1 is a diagram of a sales training video system.

FIG. 2 is a flowchart of a method for delivering sales training videos.

FIG. 3 is a diagram of data structures for delivering sales training videos.

FIG. 4 is a diagram of mappings for content attributes.

FIGS. 5A-5B are diagrams of mapping storage/creation/editing.

FIG. 6 is a diagram of a feedback association data structure.

FIG. 7 is a flowchart of a method of matching content.

FIG. 8 is a flowchart of a method of uploading a video.

FIG. 9 is a diagram of account structures.

FIG. 10 is a diagram of another sales training video system.

FIG. 11 is a diagram of a video recommendation interface.

FIG. 12 is a diagram of a feedback interface.

### DETAILED DESCRIPTION

Sales training video systems and related methods are provided for recommending enterprise-grade sales training videos across one or multiple systems. A recommendation engine recommends training videos and tunes recommendations based on business outcomes associated with customer relationship management (CRM) objects such as sales opportunities. Videos that provide the right training at the right time for a given CRM object are recommended for future CRM objects that share similar characteristics. Further advantages will also become apparent in the below description, in which sales opportunity is referenced as a salient example of a CRM object.

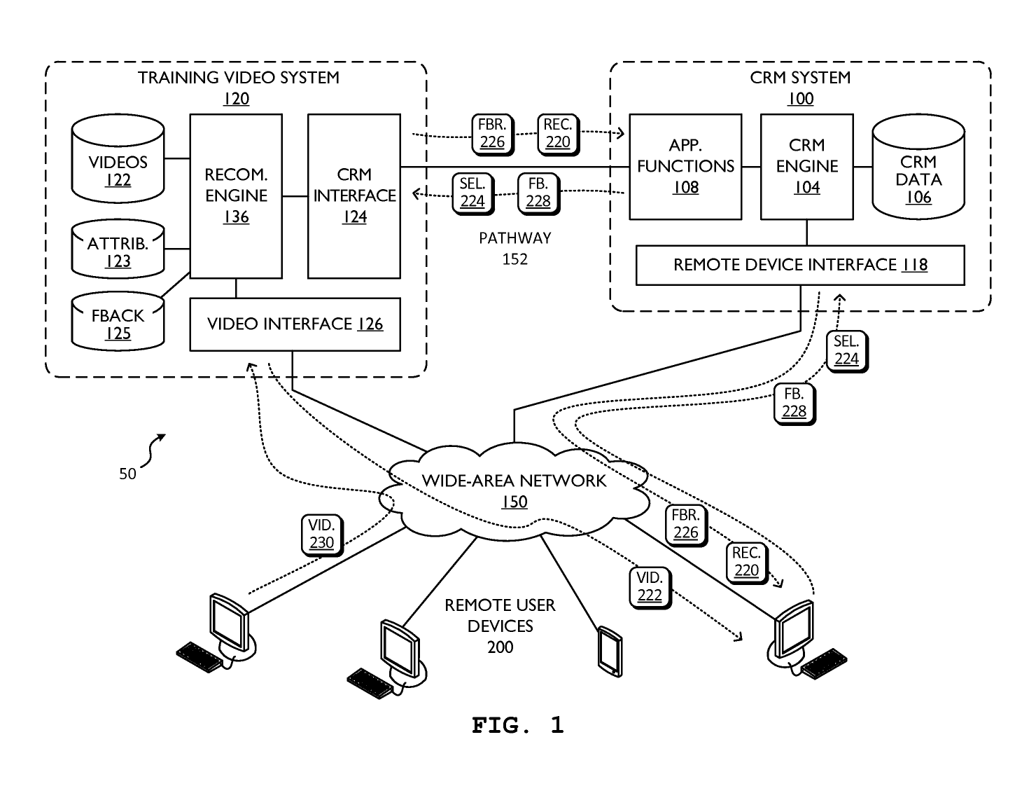

As shown in FIG. 1, a computer-based system 50 for sales training includes a customer relationship management (CRM) system 100, a training video system 120, a wide-area network 150, and a plurality of remote user devices 200. In this embodiment, the remote user devices 200 access the CRM system 100 via the network 150 and access much of the functionality of the training video system 120 through the CRM system 100. The training video system 120 can be an application (“app”) or add-on for the CRM system 100. In other embodiments, the training video system 120 is a stand-alone system that interfaces with one or more CRM systems 100, and much or all of the functionality of the training video system 120 can be accessed directly by the user devices 200 via the network 150. It is to be understood that system 50 is merely an example configuration and that other configurations of hardware components can be provided which deliver substantially the same functionality according to the overall teachings herein.

The wide-area network 150 includes local networks forming part of the systems 100, 120 as well as a wider system, such as the Internet. The wide-area network 150, and particularly the coupling to the devices 200, may include a wireless local-area network, a cellular network, or similar network to permit the devices 200 to be portable. The wide-area network 150 supports protocols to facilitate secure communications between the systems 100, 120, such as Hypertext Transfer Protocol Secure (HTTPS) and Secure Socket Layer (SSL), for example.

The remote devices 200 each include a processor, memory, a network interface, and a display and other user-interface components. The processor, memory, network interface, display, and user interface are electrically interconnected and can be physically contained within a housing or frame. A device 200 may be a desktop computer, portable computer, smartphone, tablet computer, or the like. The devices 200 need not be limited to use by salespeople, and it is advantageous that other users, such as managers and system administrators can use devices 200 to access the system 50. The processor of each of the devices 200 is configured to execute instructions, which may originate from the memory or the network interface of the device. The processor may be known as a central processing unit (CPU). The processor can include one or more sub-processors or processing cores. The memory of each of the devices 200 includes a non-transitory computer-readable medium that is configured to store programs and data. The memory can include one or more short-term or long-term storage devices, such as a solid-state memory chip (e.g., DRAM, ROM, non-volatile flash memory), a hard drive, an optical storage disc, and similar. The memory can include fixed components that are not physically removable from the terminal (e.g., fixed hard drives) as well as removable components (e.g., removable memory cards). The memory allows for random access, in that programs and data may be both read and written. The network interface of each of the devices 200 is configured to allow the terminal to communicate with servers and terminals across one or more networks. The network interface can include one or more of a wired and wireless network adaptor and well as a software or firmware driver for controlling such adaptor. The display and other user interface components can include a display device, such as a monitor and an input device, such as a keyboard, keypad, mouse, touch-sensitive element of a touch-screen display, or similar device. Each of the devices 200 is configured to run a user agent, such as a web browser, application, or other suitable program to communicate with the CRM system 100 and training video system 120.

The CRM system 100 and training video system 120 can each include one or more servers that include a processor and connected memory. The processor is configured to execute instructions, which may originate from the memory or a network. The processor may be known as a CPU. The processor can include one or more sub-processors or processing cores. The memory includes a non-transitory machine-readable medium that is configured to store programs and data. The memory can include one or more short-term or long-term storage devices, such as a solid-state memory chip (e.g., DRAM, ROM, non-volatile flash memory), a hard drive, an optical storage disc, and similar. The memory can include one or both of fixed components that are not physically removable (e.g., fixed hard drives) and removable components (e.g., removable memory cards). The memory allows for random access, in that programs and data may be both read and written. The processor and memory operate in conjunction to execute the engines, databases, and similar components discussed herein. It is contemplated that multiple of such servers can be used to implement the functionality described. Various functional components can be provided to various servers, and servers need not be co-located.

The CRM system 100 includes a CRM engine 104, CRM data 106, configurable application functions 108, and a remote device interface 118.

The CRM engine 104 is configured to operate on the CRM data 106 to manage CRM objects such as opportunities, leads, customers, cases, after-sales services, accounts, contacts, and other data related to activities managed within the CRM system 100. CRM objects can include any suitable programmatic entity such as database records, instances of classes or other data structures, or similar. Attributes of CRM objects can include values in database fields, variable/field values of class instances, or similar. Each CRM object and its attributes represents a discrete unit of CRM data, be it an opportunity, lead, etc., as listed above. The CRM engine 104 can be embodied as an executable program and the CRM data 106 can be stored as one or more databases. CRM objects

The remote device interface 118 is configured to receive input data from the devices 200 for entering, viewing, and selecting CRM objects represented by CRM data 106. The remote device interface 118 includes a web server that generates webpages based on CRM data 106, outputs such webpages to the devices 200, and accepts input from such webpages to enter, view, and select the underlying CRM data 106. The remote device interface 118 need not be limited to a web server generating webpages and can, alternatively or additionally, be configured to support the viewing and manipulation of CRM objects represented by CRM data 106 via a dedicated application or similar program executing at the devices 200.

The configurable application functions 108 allow configuration of certain functionality of the CRM engine 104 for the training video system 120. The configurable application functions 108 can include, for example, configurable database fields, content services, scripting services, and similar entities that allow a degree of customization of the CRM system 100. The training video system 120 can be implemented as a specific customization of the configurable application functions 108. In other embodiments, the configurable application functions 108 include an application programming interface (API) that exposes certain functionality of the CRM engine 104 to the training video system 120.

The CRM system 100 can be any known CRM system such as Salesforce.com™, Salesforce Service Cloud™, Microsoft Dynamics CRM™, SugarCRM™, Zendesk™, Parature™, RightNow™, Veeva Systems™, HubSpot™, or similar. In addition, the present invention is not limited to CRM systems and can be applied to call center management systems, customer engagement management systems, and the like.

The training video system 120 can be tightly integrated with the CRM system 100 as, for example, a programmed configuration of the configurable application functions 108. A pathway 152 between the training video system 120 and the configurable application functions 108 may thus represent connections between configurable functionality of the CRM system 100 and non-configurable or base functionality of the CRM system 100. Alternatively or additionally, the pathway 152 can include the network 150. In other embodiments, the pathway 152 includes a private network that is distinct from the network 150.

The training video system 120 includes a CRM interface 124, a video interface 126, a recommendation engine 136, a library of sales training videos 122, content attributes (tags) 123 of the sales training videos 122, and feedback associations 125 for the sales training videos 122. The specific configuration of the training video system 120 is not limited. In this embodiment, the video interface 126 and the library of sales training videos 122 are implemented on specialized servers different from the server or servers that implement the recommendation engine 136, the CRM interface 124, the content attributes 123, and the feedback associations 125.

The CRM interface 124 represents a particular configuration of the configurable application functions 108 to realize the functionality discussed herein. In other embodiments, such as when an API is used to implement the configurable application functions 108, the CRM interface 124 can be configured to provide data communications between the training video system 120 and the CRM system 100. That is, the CRM interface 124 can manage commands and data passed between the systems 120, 100.

The video interface 126 is configured to communicate video data between the training video system 120 and the remote user devices 200. Communication of video data includes video playback, playback commands, and uploading of videos, as well as communication of data related to the videos. Actual video data, in this embodiment, does not pass through the CRM system 100, but in other embodiments it can.

The content attributes 123 represent relationships between content of the sales training videos 122 and CRM data 106 stored at the CRM system 100. Content attributes 123 can include properties about videos, such as playback time, as well as sales-related information such as size of opportunity (e.g., as measured in dollars), monetary amounts, stage, competitors, product or service, industry, and similar. Sales-related content attributes help match videos with opportunities and other CRM objects in the CRM system 100 that have the same attributes, similar attributes, or mapped attributes.

Other attributes are also contemplated, such as company and user attributes. Company attributes uniquely identify companies that use the CRM system, or divisions of such companies, so that sales training videos may be kept private to companies that subscribe to the same CRM system 100. User attributes identify user types, position, and other characteristics that can be used to influence which videos are presented to which users.

The feedback associations 125 track instances of feedback provided by users of the devices 200 for various videos 122, where such feedback is tied to CRM data 106, such as one or more sales opportunities. The feedback associations 125 are used to update the content attributes 123 of videos 122 to provide improved recommendation of training video and help enable training videos to support and drive sales.

Each of the training video system 120 and the CRM system 100 may have further components, not shown for clarity, such as user access management components, session management components, and similar.

The recommendation engine 136 is configured to select one or more of the sales training videos 122 based on the content attributes 123 of the sales training videos, output indications, such as recommendations 220, of the one or more sales training videos 122 to the remote devices 200, and initiate playback of delivered sales training videos 222 at remote devices 200 in response to selections 224 received from remote devices 200. Recommending videos 122 to a particular device 200 can be performed based on matching content attributes 123 of the videos to CRM data 106 being viewed by the particular device 200. That is, recommendations can be based on context. Recommendations can also be based on other factors, such as user attributes.

The recommendation engine 136 is further configured to output feedback requests 226 to remote devices 200 after or during playback of delivered sales training videos 222. In response, the recommendation engine 136 receives user-specified feedback data 228 for delivered sales training videos 222 from remote devices 200. User-specified feedback data 228 can indicate a particular CRM object stored in the CRM system 100, which the viewer of the video identifies as being the related to or the purpose of watching a particular sales training video 222. That is, user-specified feedback 228 can be used to relate sales training videos 222 to data within the CRM system 100, particularly data related to sales activities that can assisted by the training provided by the videos 222. User-specified feedback 228 is stored in the training video system 120 as feedback associations 125.

Recommendations 220 and feedback requests 226 are transmitted from the training video system 120 to the CRM system 100, which transmits recommendations 220 and feedback requests 226 to the relevant remote devices 200. Selections 224 of recommended videos and feedback 228 concerning videos are transmitted from the remote devices 200 to the CRM system 100, which transmits the sections 224 and feedback 228 to the training video system 120. Actual videos 222 are delivered from the training video system 120 to the relevant remote devices 200 directly and need not pass through the CRM system 100.

The recommendation engine 136 is configured to monitor the state of any related data within the CRM system 100 and update at least one content attribute of a watched sales training video 122 upon detection of changes to such data. For example, when a CRM object is associated with a particular video 122 through a feedback association 125, the recommendation engine 136 can update the relevant content attribute 123 of the particular video 122 upon detecting advancement of that sales CRM object's stage. Updating content attributes 123 can include assigning a previously unassigned content attribute to a video, increasing a score associated with an already assigned content attribute, a combination of these, or similar. Hence, the outcome that a particular training video had on the CRM object can be stored and referenced to inform future training video recommendations.

CRM object stages are temporal states that represent change over time. Stages can include clearly defined stages for a CRM object, such as an opportunity, that has a finite life. Stages can also include looser, arbitrary stages for a permanent CRM object, such as periodic communications with a contact. Any number of CRM stages can be used. Stages move to resolution. In the example of an opportunity, resolution can be a closed sale. In the example of a contact, resolution can be completion of a communication, such as a telephone call or email message. In the example of an account, resolution can be transition to a customer stage, e.g., “Customer” from another stage, e.g., “Lead”. Other varieties of stages for other CRM objects are also contemplated.

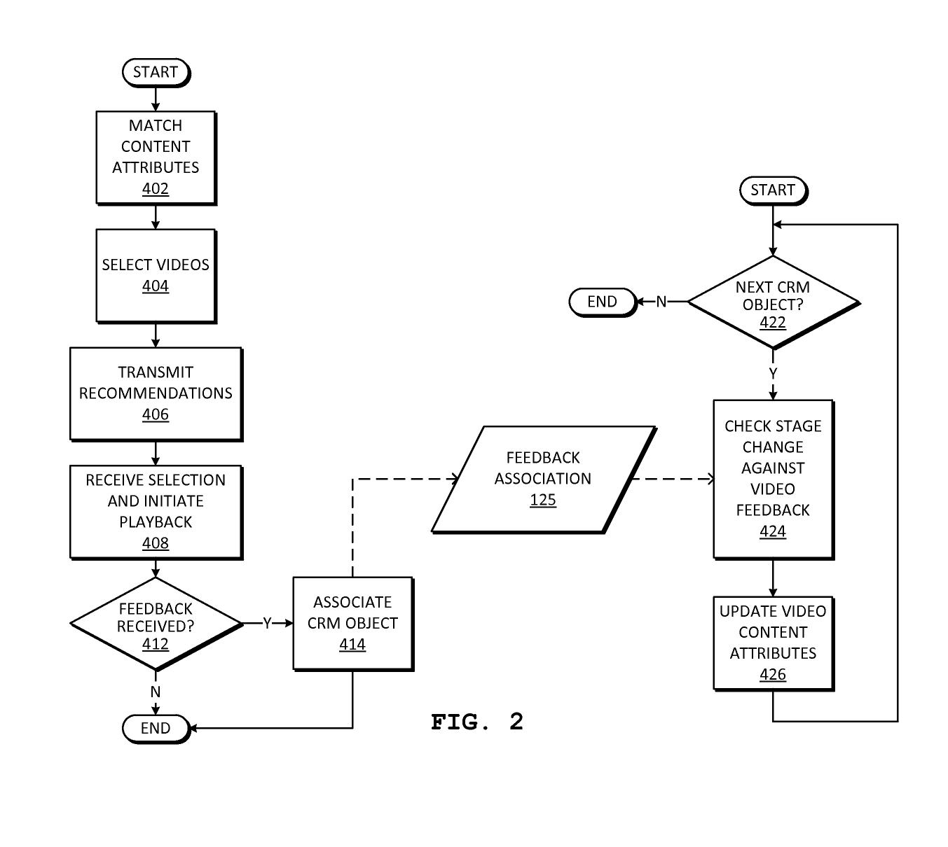

FIG. 2 method for delivering sales training videos in a computer network. This method can be performed with the system 50 discussed above, but this is not limiting. Various steps of the method can be performed together, can be split into smaller sub-steps, and can be performed in sequences different from shown.

Content attributes of sales training videos are matched, at step 402, with context at the CRM system 100. That is, as a user browses data in the CRM system, content attributes are compared to the CRM data to match videos to the CRM data. For example, if a user is viewing a sales opportunity in the pharmaceutical industry, then videos having content attributes related to this industry are obtained as matches.

Then, one or more of the sales training videos are selected, at step 404, based on the matching of video content attributes to the CRM data.

At step 406, indications of the one or more selected sales training videos are transmitted to the relevant remote device 200. Such indications may include video thumbnails, previews, titles, metadata, or similar and may be presented in a list or grid arranged by date, relevance, or some other characteristic.

Then, at step 408, playback for the remote device 200 of a particular sales training video is initiated. This can occur when the user at the remote device 200 selects the particular sales training video.

At step 412, after or during playback of the particular sales training video, a feedback request is sent to the remote device 200. This can be performed at the end of the video, if the user commands a stop or pause to the video, if the user moves focus away from the video player, or in response to another similar event. If user-specified feedback data is received from the remote device 200 and the user-specified feedback data indicates a particular CRM object stored in the CRM system 100, then the particular CRM object is associated with the video, at step 414, by the creation of a feedback association 125.

Feedback associations 125 are stored to track videos that have been identified as being relevant to particular CRM objects. Feedback associations 125 include associations of identifiers of videos and identifiers of CRM objects, and may include further data concerning how content attributes are to be updated when a stage changes.

Steps 402-414 are performed as users at remote devices 200 view data and perform other operations at the CRM system 100.

Steps 422-426 are performed periodically or as triggered by updates to CRM objects within the CRM system 100. As CRM objects are iterated through, or as each CRM object's stage changes, at step 422, the method checks CRM objects whose stages have changed against feedback associations 125 provided through user feedback, at step 424. That is, steps 422, 424 check user-specified feedback data indicating a particular CRM object as being related to a particular video and determines whether the stage of the particular CRM object has changed.

Then, upon detection of an advancement of a stage of the particular CRM object, at least one content attribute of the particular sales training video is updated, at step 426. Rules for updating content attributes may be applied at step 426. For example, feedback associations 125 older than a certain age may not act to update content attributes (or may have a reduced effect) and may instead be ignored or deleted, based on the assumption that the effect of a video on a CRM object diminishes over time. In another example, only advancement to a successful closing stage results in content attribute being updated.

Steps 402-414 that present videos and capture feedback are performed independent and asynchronously with steps 422-426 that monitor CRM object changes and update video content attributes based on captured feedback. Steps 402-426 are examples only and other processes, which may be structured differently, can perform the same actions. For example, rather than iterating through each CRM object, an event trigger methodology may be used to update video content attributes. In still another example, video content attributes are resolved at the time that a video is being recommended, and queries as to CRM object stages can be performed at that time, as necessary.

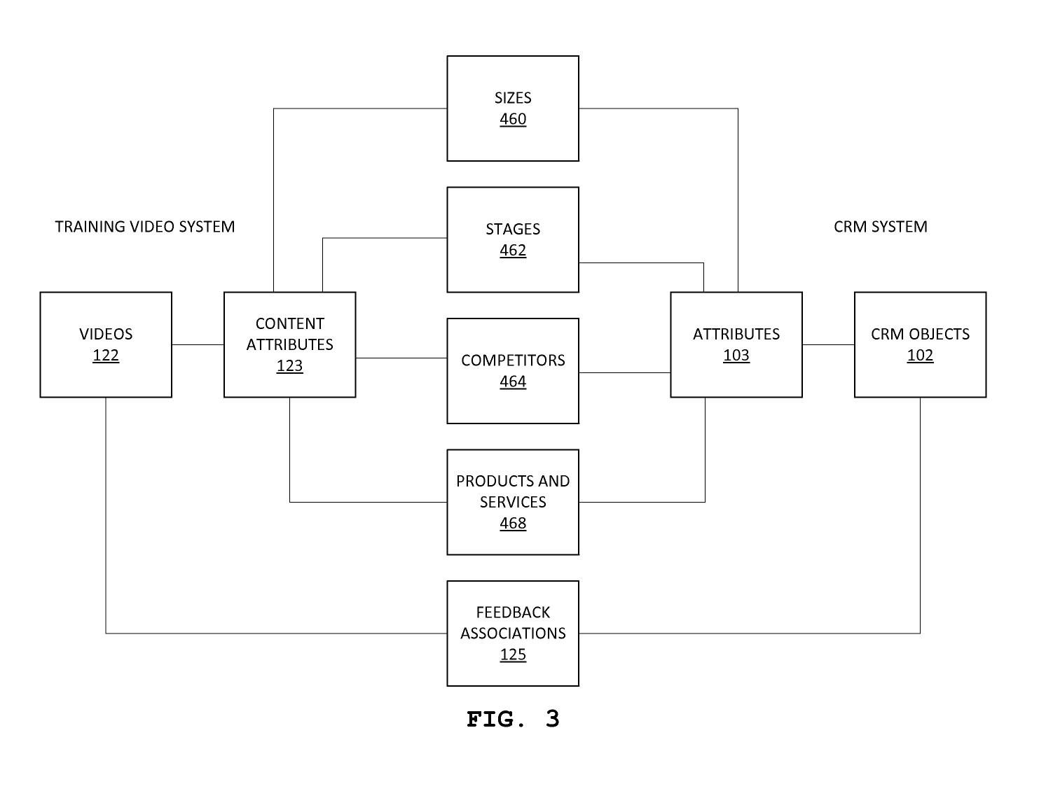

FIG. 3 shows an overall data structure and relationship for use with the systems and methods described herein.

CRM data 106 can represent objects that include attributes. Examples of CRM objects include opportunity, lead, customer, case, after-sales service, account, and contact. CRM objects 102 can include attributes 103 that define or characterize the object. Taking opportunities as an example, example attributes 103 can include the size 460 of the opportunity (e.g., as measured in dollars), monetary amounts related to the opportunity, the stage 462 of the opportunity (e.g., prospecting, quote, closed, etc.), the competitors 464 who may or may not be acting on the opportunity, the product or service 468 being sold, the industry in which the opportunity exists (e.g., manufacturing, healthcare, high tech, etc.), and similar. Each CRM object 102 can have a one-to-one or one-to-many relationship with the attributes 460-468. For example, each opportunity object 102 can have one size, one current stage 462, one or more competitors 464, and one or more product or services 468. For other examples of CRM objects, various different, additional, or alternative attributes 103 are contemplated. For example, for a contact object, attributes may include title and seniority.

Videos take the same attributes 460-468 as content attributes 123 or tags. Each video 122 can have many attributes. For example, each video can be suitable for opportunities of one or more sizes 460, at one or more stages 462, with one or more competitors 464, and for one or more product or services 468.

Examples of sizes 460 include descriptive groups (e.g., small, medium, large) and numerical groupings (e.g., $0-9,999, $10,000-99,999, etc.). Sizes 460 can represent the boundaries of bins.

Examples of opportunity stages 462 include descriptive stages such as “Prospecting”, “Qualification”, “Needs Analysis”, “Value Proposition”, “Identify Decision Makers”, “Perception Analysis”, “Proposal/Price Quote”, “Negotiation/Review”, “Closed—Lost”, “Closed—Won”, to name a few. Closed stages represent resolutions. Examples of contact stages 462 can include “Needs Contact”, “Recent Contact Made”, or similar with resolution being recent contact made. Examples of contact stages 462 can include various relationship states from none, to lead, to customer, for example. Various stages are contemplated for various different CRM objects, and examples of specific stages are not limiting.

Competitors 464 and products and services 468 can be stored as text strings, unique identifiers (e.g., corporation registration numbers, serial numbers, etc.), or similar.

Project and service attributes 468 are particularly relevant for CRM objects 102 such as account and contact. For instance, it may be useful to provide training to sales reps including videos that target the products and services being sold and/or competitor products and services. That is, a particular video may be useful to train a sales rep for a specific product or service. For example a contact CRM object 102 for a doctor may have products and services 468 attributes that indicate the types of medications prescribed. Then, before a sales rep offering competing medications contacts the doctor, the sales rep can consume video training relevant to the medication, so that the layperson sales rep can speak in a knowledgeable manner with the expert doctor. Similarly, an account CRM object 102 for a hospital may indicate medical devices used and usage statistics. Then, before a sales rep offering competing medical devices contacts the account contact, the sales rep can consume video training relevant to the medical devices used at the hospital.

Feedback associations 125 associate videos 122 with CRM objects 102, so that when an object's key attributes 103 change, such as its sales stage, the relevant videos may be identified to have their content attributes updated accordingly.

It is also contemplated that video training may be recommended based on “global” data of the CRM data 106. Global data includes fields that are not relevant to a particular CRM object, but that are relevant to a collection of CRM objects, such as, for example, all CRM objects for a particular client. That is, a specific client may be represented by various disparate CRM objects, such as opportunities, contacts, and accounts, etc., and global data may be set at the CRM system 100, so as to push particular training videos to all users of the CRM system 100 who interact with such client.

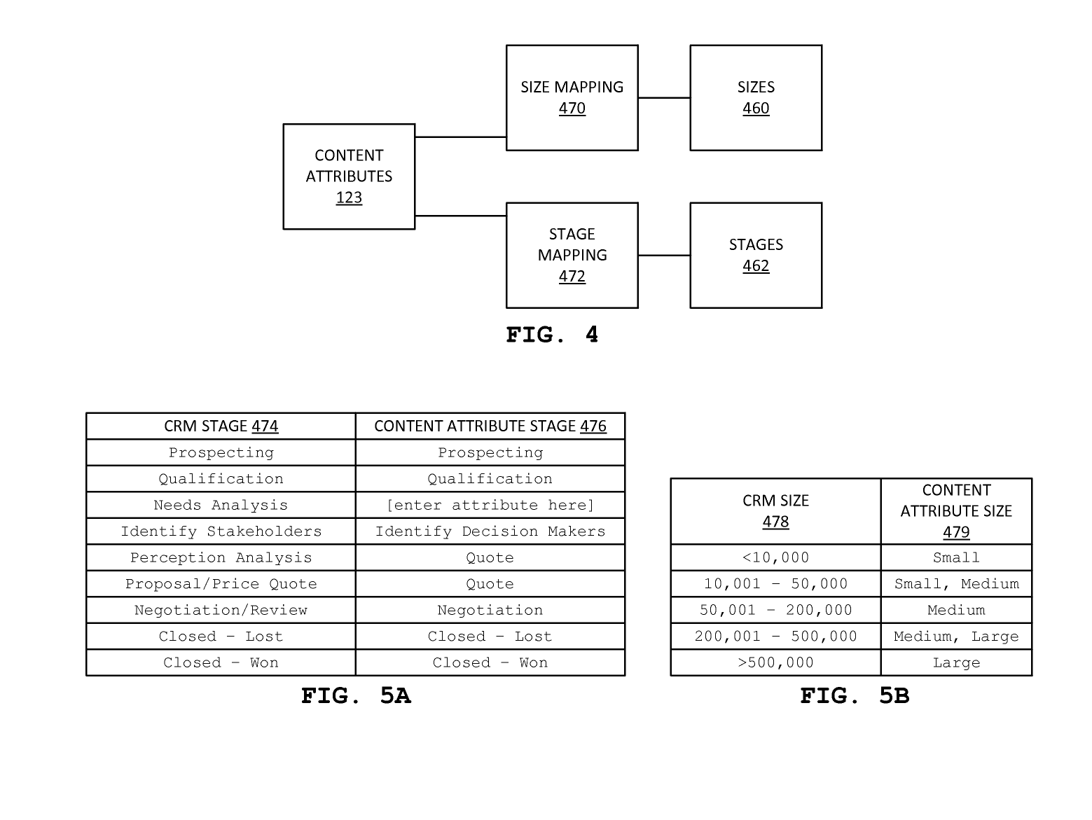

With reference to FIG. 4, it is contemplated that attributes 103, such as sizes 460 and stages 462 of opportunities, are governed by the CRM system 100 or by configurations of the CRM system 100 by its users (e.g., operating or subscribing companies). Accordingly, mappings may be provided to normalize different definitions of the same or similar attributes to a common definition. A size mapping 470 can be used to relate sizes 460 to video content attributes 123. For example, one user of the CRM system 100 may consider large deals to be over $1 million, whereas another user may consider large deals to be $10,000 or more. It is contemplated that both users may want to see videos related to “large” deals. Similarly, a stage mapping 472 can be used to relate stages 462 to video content attributes 123. A particular user of the CRM system 100 may define stages 462 differently from another user, and the sales training videos 122 may be made available to both such users relative to their different stage definitions. Hence, the training video system 120 can store one stage mapping 472 for one user and a different stage mapping 472 for a different user. The same applies for size mappings 470. Mappings 470, 472 need not be precisely one-to-one. That is, if a user defines more stages for CRM objects than exist for videos 122, then the stage mapping 472 can be selected to map multiple CRM stages 474 to one content attribute stage 476. Conversely, if a user defines fewer stages for CRM objects than are defined for videos 122, then the stage mapping 472 can be selected to map multiple content attribute stages 476 to one CRM stage 474.

Mappings for competitor, product and service, and other attributes may also be provided. In such cases, a mapping can be made to a generic category, such as “Main competitor”, “Minor competitor”, “Core product”, “Support service”, and similar. This enables many possible competitors, products, and services, even those unknown to the training video system 120 to be mapped to the sales training videos.

FIG. 5A shows an example data structure and related user interface for storing, creating, and editing a stage mapping 472. Text boxes allow entry of stages 476, as stored as content attributes 123 for the videos. The example text shown relates to opportunities. CRM stages 474 are configured by users of the CRM system 100 and are not generally expected to be modifiable by the training video system 120. When a CRM stage 474 is encountered, the stage mapping can be used to look up the corresponding content attribute stage 476. Likewise, when a content attribute stage 476 is encountered, the stage mapping can be used to look up the corresponding CRM stage 474. Similar mappings are contemplated for the other attributes, such as monetary sizes, as shown in FIG. 5B, in which CRM sizes 478, as configured by a particular user, are mapped to content attribute sizes 479. FIG. 5B also illustrates that multiple content attributes values can be mapped to a single CRM value. This can be achieved in the user interface by, for example, comma-separated values.

With reference back to FIGS. 3 and 4, matching of sales training videos 122 to CRM objects 102 is performed by identifying content attributes 123 that map to attributes, whether directly or through an intermediate mapping.

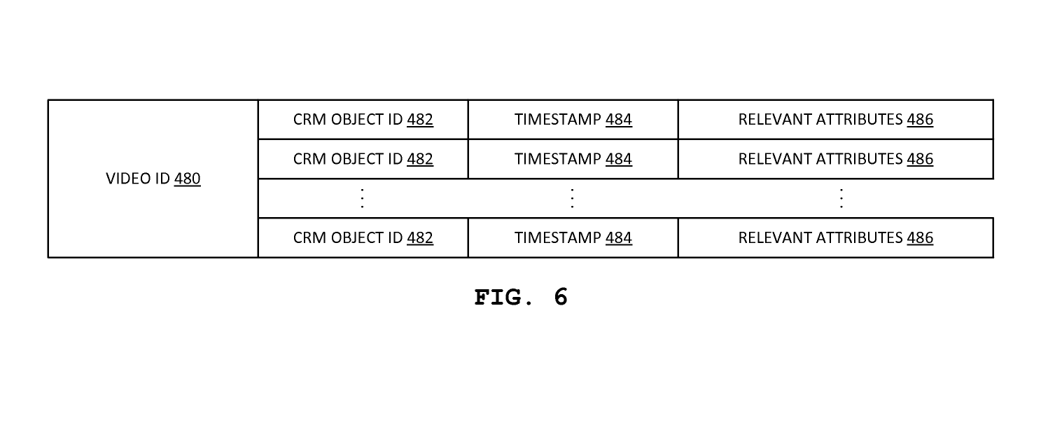

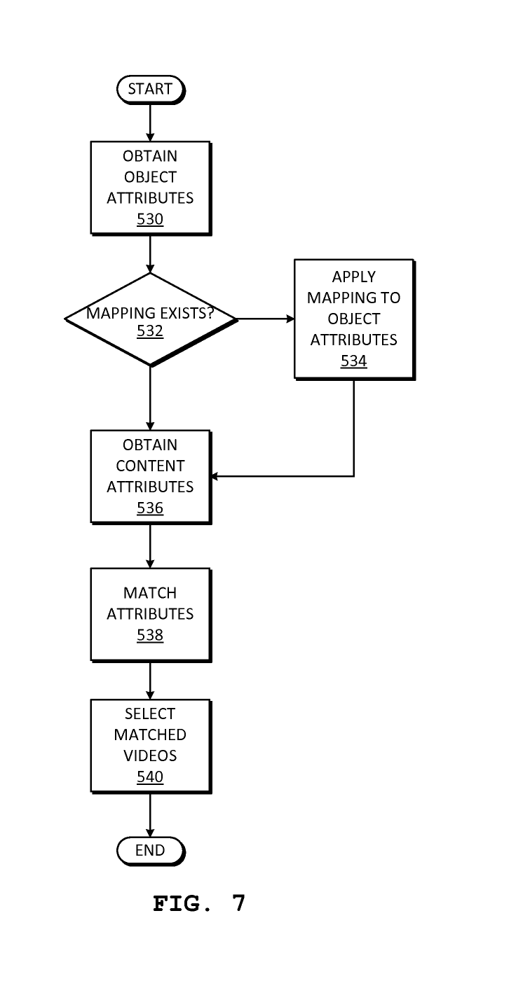

FIG. 6 shows a data structure for feedback associations 125. A video unique identifier 480, such as a hash, filename, or similar, is associated with one or more unique CRM object identifiers 482, as stored at the CRM system 100. A timestamp 484 records the time that the feedback ways provided, so as to allow for dropping or downgrading of older feedback. Relevant attributes 486 are those attributes that the identified CRM object had at the time the feedback was provided. Alternatively, the relevant attributes 486 can be taken as the attributes at the time when the feedback is processed for updating content attributes.

With reference to step 426 of FIG. 2, when a CRM object 102 identified in a feedback association 125 progresses to the next stage, the sales training video 122 identified in the feedback association 125 is assigned content attributes equivalent (i.e., after applying any mappings) to the relevant attributes 486 for that CRM object 102. In some embodiments, content attributes are given scores so that additional positive feedback for a video increases that video's score for an attribute. Scores may be normalized and may undergo other mathematical/statistical processing. In other embodiments, content attributes are present or absent, and assigning an already present content attribute does nothing. Optionally, the age of the feedback, as indicated by the timestamp 484, may be used to reduce a score or to not apply a content attribute, based on the assumption that the training provided by the video was too long ago to have significant effect on the progression of the CRM object.

FIG. 7 shows a flowchart of a matching process, which can be used to implement step 402 discussed above. Various steps of the method can be performed together, can be split into smaller sub-steps, and can be performed in sequences different from shown.

At step 530, attributes of a CRM object are obtained. The CRM system 100 is queried to obtain at least one opportunity attribute of an available CRM object, such as an opportunity. This can be performed as a user browses sales opportunities within the CRM system 100, for example. CRM object attributes include characteristic data of CRM objects and are readily available when the CRM system 100 is querying and outputting data about a CRM object.

Next, at step 532, the method determines whether a mapping exists for this user. If one or more mapping exists, then, at step 534, the mapping is applied to the CRM object attributes to obtain attributes that can be directly compared to content attributes. If no mapping exists, then it is assumed that a direct comparison can be performed.

At step 536, content attributes are obtained for various sales training videos 122. Then, at step 538, the CRM object attributes are matched to the content attributes. Steps 536 and 538 can be performed by querying the content attributes 123 of all videos 122 using the CRM object attributes obtained at steps 530, 534.

Matched videos are then selected, at step 540, based on matching criteria applied to the output of step 538. In this embodiment, any video 122 that has a matched content attribute is considered matched to the CRM object. In other embodiments, a threshold number of matched content attributes qualify a video 122 as matched. Matched videos 122 may be ranked based on the number of matched attributes. Attributes may also be weighted and the ranking may be a weighed ranking.

With reference back to FIG. 1, new sales training videos 230 may be uploaded from remote devices 200 to the training video system 120 for storage in the library of sales training videos 122 and for playback at other remote devices 200 according to the techniques discussed herein. This can facilitate user-created content, third-party created content, and impromptu or on-location training, tips, and advice.

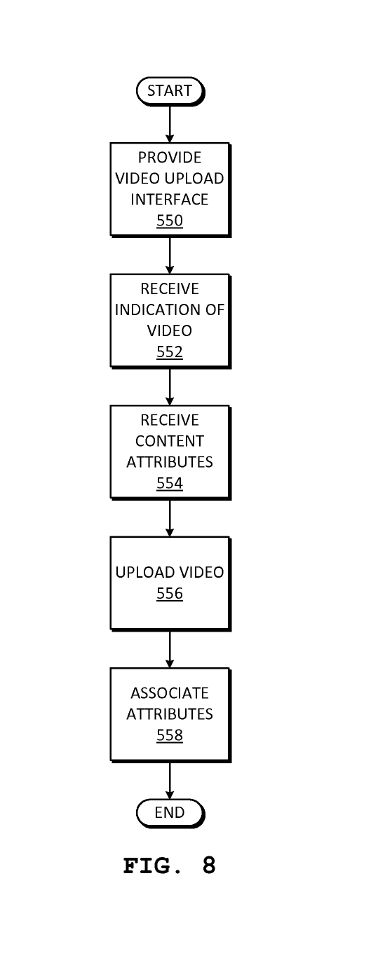

FIG. 8 shows a method for uploading sales training videos 230. The method can be performed with the system 50, though this is not limiting. Various steps of the method can be performed together, can be split into smaller sub-steps, and can be performed in sequences different from shown.

At step 550 a video upload interface is provided to a remote device 200 that has requested to upload a video. The upload interface can be provided by the training video system 120 thought the remote device interface 118 of the CRM system 100. The upload interface can include, for instance, a web page or application screen that allows selection and/or immediate capture of a video.

At step 552, an indication of the video to upload is received. This can occur at by a selection or capture of a video at the remote device 200.

The upload interface can also include a content attribute selection interface that allows user selection of content attributes for the video to be uploaded, at step 554.

At step 556, the video is uploaded from the remote device 200 to the training video system 120. While some of the steps of the method can be performed in whole or in part by the CRM system 100, in this embodiment, step 556 is performed by the remote device 200 and the training video system 120. That is, the video itself is not transmitted through the CRM system 100. The selected attributes of the video may be transmitted through the CRM system 100.

At step 558, the one or more selected content attributes from step 554 are associated with the uploaded sales training video in the training video system 120. A company attribute may be associated with the uploaded sales training video without intervention by the user provided that the user is logged in when uploading the video. The company attribute may signify which users have access to the video.

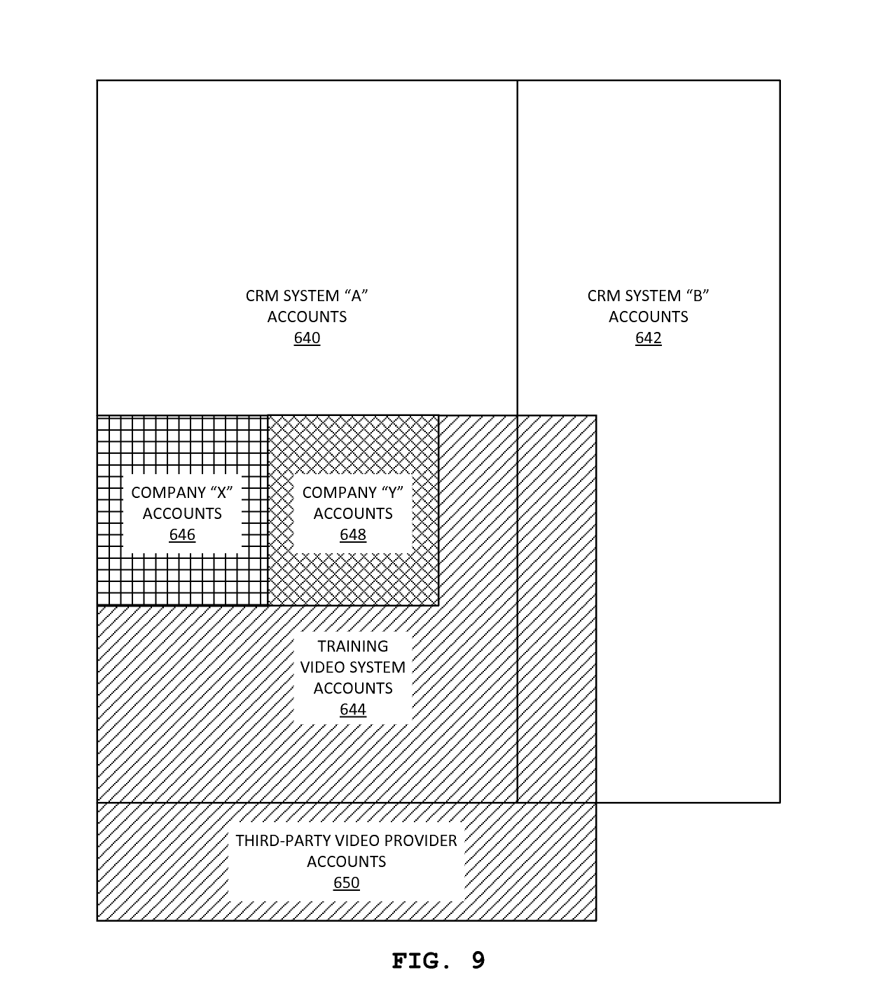

FIG. 9 shows a user account structure for use with the techniques discussed herein. User accounts represent individual users and/or company users. It is contemplated that a company operates or subscribes to a CRM system and each of the company's users are provided with a subset of the data access permissions controlled by the company.

CRM system accounts 640 represent all accounts on a first (“A”) CRM system 100 and CRM system accounts 642 represent all accounts on a second (“B”) CRM system 100, which may be of the same or a different type. Any number of CRM systems 100 is contemplated.

Training video system accounts 644 represent all accounts on the training video system 120. Some of the training video system accounts 644 are also accounts on the first (“A”) CRM system 100 and others of the training video system accounts 644 are also accounts on the second (“B”) CRM system 100. That is, the training video system 120 can be configured to support multiple and different CRM systems.

Within training video system accounts 644 are first (“X”) company accounts 646 and second (“Y”) company accounts 648. All company accounts 646, 648 belong to one of the CRM systems 100 and to the training video system 120. Company accounts 646, 648 can be private within the training video system 120, so that users at one company cannot view the videos of another company. Any number of companies can be supported by the training video system 120. It is also contemplated that a particular sales training video can be exclusively associated with one set of company accounts 646, 648 (e.g., internal videos), exclusively associated with more than one set of company accounts 646, 648 (e.g., shared videos, third-party videos, or videos provided by an operator of the training video system 120), or associated with all training video system accounts 644.

Within training video system accounts 644 may also be third-party video provider accounts 650 operated by sales training video creators or providers, who do not use the CRM system 100 and rather make their content available to various company accounts 646, 648 within the training video system 120.

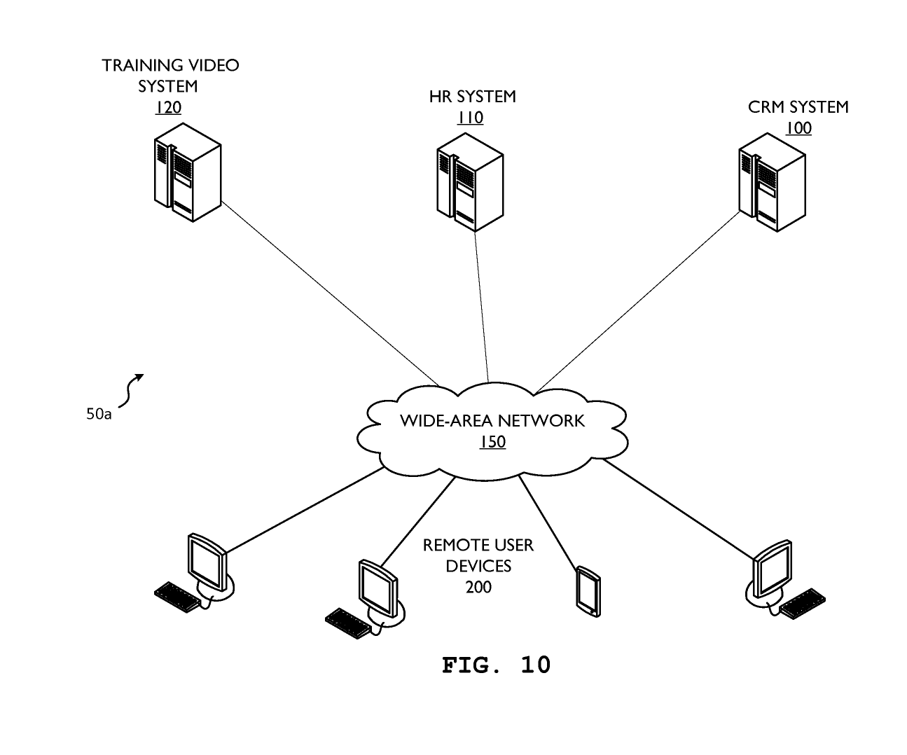

FIG. 10 shows another computer-based system 50a for sales training. The system 50a is similar to the system 50 and only differing components will be described in detail. The system 50a includes a CRM system 100, a training video system 120, a wide-area network 150, and a plurality of remote user devices 200. At 110, the system 50a further includes a human capital management (HCM) system or a human resources information system (HRIS), such as that provided by SAP Success Factors™, Oracle Taleo™, Ultimate HR™, Workday™, Cornerstone OnDemand™, SumTotal™, SilkRoad HR™, Saba™, and similar.

The HR system 110 stores information about users of the training video system 120 and the CRM system 100. User attributes stored in the HR system 110 can be used to select videos from the training video system 120 and can be referenced applying content attributes to the videos through feedback. The steps 402, 404 of FIG. 1 can further include obtaining at least one sales representative attribute from the HR system 110 and matching content attributes of the sales training videos to the at least one sales representative attribute. Selecting sales training videos is performed based on the user matching and CRM object matching. As for feedback, videos can be assigned user attributes based on CRM object stage advancement, so that other users who share the same attributes will be recommended such videos. Examples of user attributes include job title, skills (e.g., negotiating, listening, motivating), certifications, and similar.

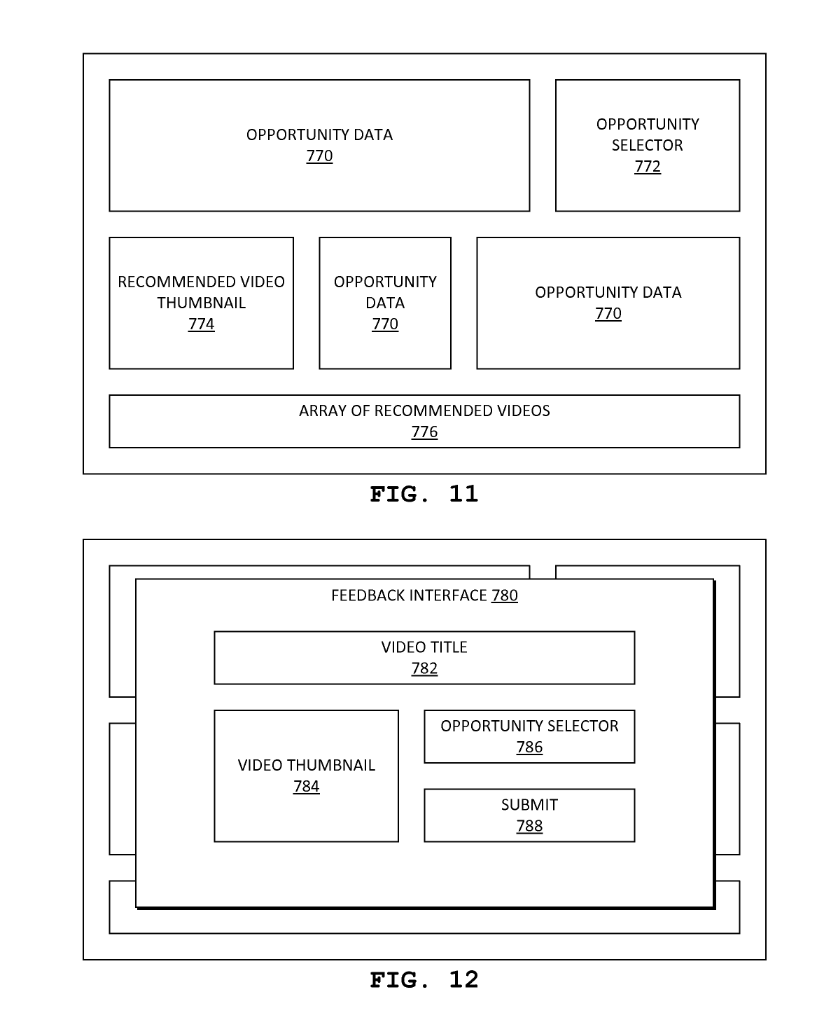

FIG. 11 shows output of video recommendations among CRM object data. Taking sales opportunity as an example CRM object, opportunity data 770 is displayed at a remote device 200. An opportunity selector 772 permits selection of another, different opportunity. A recommended video thumbnail 774 of a highly recommended video is selected and represented based on the current opportunity data 770. Other recommended videos are presented as an array or grid 776.

After or playback of a video, or during an interruption of playback, a feedback interface 780 is presented, as shown in FIG. 12. The feedback interface 780 includes an identification of the video, such as its title 782 and a thumbnail 784, an opportunity selector 786 (e.g., a dropdown selector), and a submit button 788. The opportunity selector 786 may be preselected if the user was browsing an opportunity at the time of video playback initiation. Similar interfaces as those shown in FIGS. 11 and 12 are contemplated for other types of CRM object.

The present invention provides a novel video training system that can automatically and dynamically match the relevant video content for a CRM object, such as a sales opportunity, based on characteristics of the video content and the opportunity. The present invention can create a faster and more efficient means of developing employee skills in the workplace and can use feedback to better inform future training events.

While the foregoing provides certain non-limiting example embodiments, it should be understood that combinations, subsets, and variations of the foregoing are contemplated. The monopoly sought is defined by the claims.

What is claimed is:

1. A method for delivering sales training videos in a computer network, the method comprising:
obtaining content attributes of the sales training videos, the sales training videos stored in a library of sales training videos accessible to a customer relationship management system operating on the computer network, the content attributes identifying relationships between content of sales training videos and data stored at the customer relationship management system;
selecting one or more of the sales training videos based on the content attributes of the sales training videos;
outputting indications of the one or more sales training videos to a remote device via the computer network;
initiating playback for the remote device of a particular sales training video of the one or more sales training videos;
after or during playback of the particular sales training video, outputting a feedback request to the remote device via the computer network;
receiving user-specified feedback data from the remote device via the computer network, the user-specified feedback data indicating a particular object stored in the customer relationship management system; and
upon detection of an advancement of a stage of the particular object, updating at least one content attribute of the particular sales training video.

2. The method of claim 1, further comprising:
providing a video upload interface to a plurality of remote devices;
receiving an indication of an uploaded sales training video uploaded to the library of sales training videos via the computer network using the video upload interface; and
associating one or more attributes to the uploaded sales training video.

3. The method of claim 2, wherein at least some of the plurality of remote devices are associated with accounts that are authorized by a particular company within the customer relationship management system, wherein associating one or more attributes to the uploaded sales training video comprises associating a company attribute to the uploaded sales training video, and wherein selecting one or more of the sales training videos comprises matching the particular company to the company attribute.

4. The method of claim 1, wherein the object is representative of a sales opportunity and wherein detection of the advancement of the stage comprises detection of advancement to a closing stage for the object.

5. The method of claim 1, further comprising:
querying the customer relationship management system to obtain at least one object attribute of an available object stored in the customer relationship management system; and
matching content attributes obtained for the sales training videos to the at least one object attribute;
wherein selecting the one or more of the sales training videos is performed based on the matching.

6. The method of claim 1, further comprising:
obtaining at least one sales representative attribute; and
matching content attributes obtained for the sales training videos to the at least one sales representative attribute;
wherein selecting the one or more of the sales training videos is performed based on the matching.

7. The method of claim 1, wherein the content attributes are configured to identify stages, monetary amounts, competitors, products, or a combination of such.

8. A sales training video system comprising:
content attributes identifying relationships between content of sales training videos and data stored at a customer relationship management system, the sales training videos stored in a library of sales training videos accessible to a customer relationship management system operating on a computer network; and
a recommendation engine configured to select one or more of the sales training videos based on the content attributes of the sales training videos, output indications of the one or more sales training videos to a remote device via the computer network, and initiate playback for the remote device of a particular sales training video of the one or more sales training videos;
the recommendation engine configured to output a feedback request to the remote device via the computer network after or during playback of the particular sales training video;
the recommendation engine configured to receive user-specified feedback data from the remote device via the computer network, the user-specified feedback data indicating a particular object stored in the customer relationship management system; and
the recommendation engine configured to update at least one content attribute of the particular sales training video upon detection of an advancement of a stage of the particular object.

9. The system of claim 8, further comprising a video upload interface accessible to a plurality of remote devices over the computer network, the video upload interface configured to receive an indication of an uploaded sales training video uploaded to the library of sales training videos via the computer network using the video upload interface and to associate one or more attributes to the uploaded sales training video.

10. The system of claim 9, wherein at least some of the plurality of remote devices are associated with accounts that are authorized by a particular company within the customer relationship management system, wherein the video upload interface associates a company attribute to the uploaded sales training video for matching the particular company to the company attribute when selecting one or more of the sales training videos.

11. The system of claim 8, wherein the object is representative of a sales opportunity and wherein detection of the advancement of the stage comprises detection of advancement to a closing stage for the object.

12. The system of claim 8, wherein the recommendation engine is configured to query the customer relationship management system to obtain at least one object attribute of an available object stored in the customer relationship management system and to match content attributes obtained for the sales training videos to the at least one object attribute, wherein the recommendation engine is configured to select the one or more of the sales training videos based on the matching.

13. The system of claim 8, wherein the recommendation engine is configured to obtain at least one sales representative attribute and to match content attributes obtained for the sales training videos to the at least one sales representative attribute, wherein the recommendation engine is configured to select the one or more of the sales training videos based on the matching.

14. The system of claim 8, wherein the content attributes are configured to identify stages, monetary amounts, competitors, products, or a combination of such.
